(19) United States
(12) Patent Application Publication
(10) Pub. No.: US 2026/0141073 A1
(43) Pub. Date: May 21, 2026

(54) SECURE BOOT CONFIGURATION MODIFICATION SOURCE REPORTING SYSTEM

(71) Applicant: Dell Products L.P., Round Rock, TX (US)

(72) Inventors: Wei Liu, Austin, TX (US); Gong Wang, Bellevue, WA (US); William C. Munger, Round Rock, TX (US)

(21) Appl. No.: 18/950,302

(22) Filed: Nov. 18, 2024

(51) Int. Cl. G06F 21/57

(52) U.S. Cl. CPC G06F 21/575; G06F 2221/034

(57) ABSTRACT

A BIOS secure boot configuration modification source reporting system includes a computing device housing a BIOS that is coupled to a non-volatile memory subsystem and that includes a BIOS subsystem coupled to a BIOS database storing a secure boot configuration, and to a secure boot configuration modification source identifier storage. During a current initialization of the computing device, the BIOS subsystem uses the secure boot configuration to generate a current initialization hash value, determines that the current initialization hash value does not match a previous initialization hash value that is stored in the non-volatile memory subsystem and that was generated using the secure boot configuration during a previous initialization of the computing device and, in response, retrieves secure boot configuration modification source identifier(s) from the secure boot configuration modification source identifier storage and uses them to generate secure boot configuration modification source identification message(s).

### BACKGROUND

The present disclosure relates generally to information handling systems, and more particularly to reporting a source of a modification to a secure boot configuration in a BIOS included in an information handling system.

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems such as, for example, server devices and/or other computing devices known in the art, include a Basic Input/Output System (BIOS) that may be provided with a secure boot configuration that is utilized by the BIOS to securely boot or otherwise initialize the computing device. However, the secure boot configuration for the BIOS must occasionally be modified, which can raise some issues.

For example, BIOS settings, secure boot databases (e.g., a signature database (also called a “DB” database), a revoked signatures database (also called a “DBX” database), a Key Exchange Key (KEK) database, a Platform Key (PK) database, a timestamp database (also called a “DBT” database), and/or other information in the secure boot configuration for a BIOS may be modified as part of a BIOS update, during initialization of the computing device by a user (e.g., via selection of a key (e.g., an “F2” key) on an input device (e.g., a keyboard) and the provisioning of BIOS settings modification(s)), via a Graphical User Interface (GUI) provided by a Baseboard Management Controller (BMC) in the computing device, via a personality module installed using the BMC in the computing device, via the Out-Of-Band (OOB) importation of secure boot certificates, via operating system updates performed during runtime of the computing device, and/or in a variety of other secure boot configuration modification scenarios that would be apparent to one of skill in the art in possession of the present disclosure.

In order to maintain the integrity of the secure boot configuration of the BIOS in computing devices, the BIOS identifies modifications to the secure boot configuration between each boot of the computing device. For example, during a current boot of the computing device, the BIOS may perform a hashing operation on the secure boot configuration to generate a “current” hash value, and compare it to a “previous” hash value generated via a performance of the hashing operation on the secure boot configuration during a “previous” boot of the computing device, with a modification to the secure boot configuration identified if the “current” hash value does not match the “previous” hash value. In response to identifying a modification to the secure boot configuration, the BIOS will generate a conventional secure boot warning message (e.g. a “UEFI0074” warning that “The Secure Boot policy has been modified”) and provide it for display on a display device of the computing device, while also logging that warning message in a lifecycle log.

As such, the secure boot configuration modification detection performed by conventional BIOS during initialization of the computing device may detect the modification of the secure boot configuration using any of the techniques described above and, in response, will generate the conventional secure boot warning message, and inventors of the present disclosure have found that the display of such conventional secure boot warning messages that simply identify that a modification to the secure boot configuration has occurred result in increased customer support calls even when the secure boot configuration modification was intended by the user, and even in computing devices that do not enable secure boot in their BIOS.

Accordingly, it would be desirable to provide a BIOS secure boot configuration modification system that addresses the issues discussed above.

### SUMMARY

According to one embodiment, an Information Handling System (IHS) includes a processing system; and a memory system that is coupled to the processing system and that includes instructions that, when executed by the processing system, cause the processing system to provide a Basic Input/Output System (BIOS) engine that is configured, during a first initialization of the IHS, to: generate, using a secure boot configuration, a first initialization hash value; determine that the first initialization hash value does not match a second initialization hash value that is stored in a non-volatile memory subsystem coupled to the processing system and that was generated using the secure boot configuration during a second initialization of the IHS that was performed prior to the first initialization of the IHS; retrieve, from a secure boot configuration modification source identifier storage coupled to the processing system in response to determining the first initialization hash value does not match the second initialization hash value, at least one secure boot configuration modification source identifier; and generate, using the at least one secure boot configuration modification source identifier, at least one secure boot configuration modification source identification message.

### BRIEF DESCRIPTION OF THE DRAWINGS

FIG. 1 is a schematic view illustrating an embodiment of an Information Handling System (IHS).

FIG. 2 is a schematic view illustrating an embodiment of computing device that may provide the BIOS secure boot configuration modification source reporting system of the present disclosure.

FIG. 3 is a flow chart illustrating an embodiment of a method for recording a source of modifications to a secure boot configuration in a BIOS during initialization of a computing device.

FIG. 4 is a schematic view illustrating an embodiment of the computing device of FIG. 2 operating during the method of FIG. 3.

FIG. 5 is a schematic view illustrating an embodiment of the computing device of FIG. 2 operating during the method of FIG. 3.

FIG. 6 is a schematic view illustrating an embodiment of the computing device of FIG. 2 operating during the method of FIG. 3.

FIG. 7 is a flow chart illustrating an embodiment of a method for reporting a source of modifications to a secure boot configuration in a BIOS.

FIG. 8 is a schematic view illustrating an embodiment of the computing device of FIG. 2 operating during the method of FIG. 3.

FIG. 9 is a schematic view illustrating an embodiment of the computing device of FIG. 2 operating during the method of FIG. 3.

FIG. 10 is a schematic view illustrating an embodiment of the computing device of FIG. 2 operating during the method of FIG. 3.

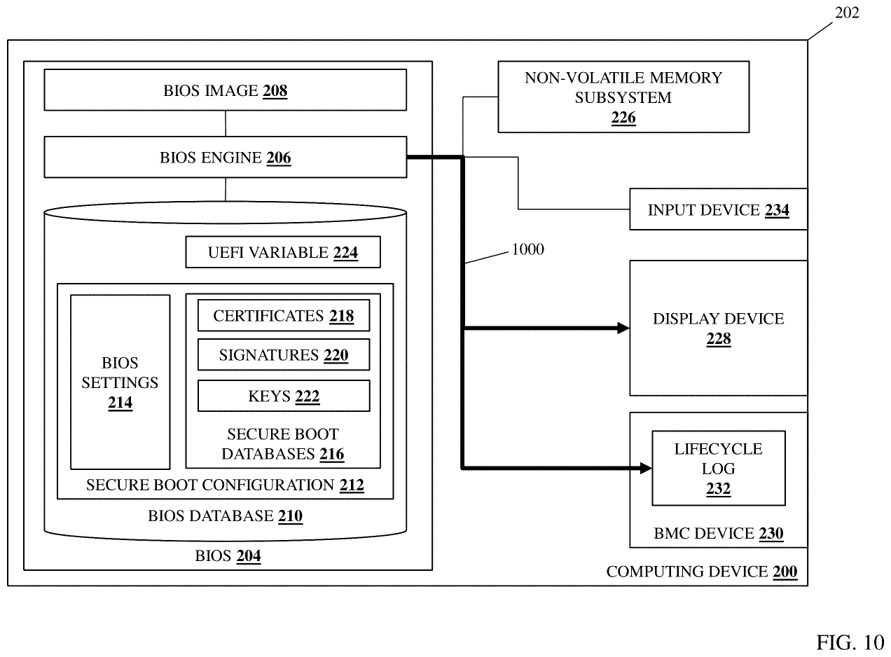

FIG. 11 is a schematic view illustrating an embodiment of the computing device of FIG. 2 operating during the method of FIG. 3.

### DETAILED DESCRIPTION

For purposes of this disclosure, an information handling system may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, mobile device (e.g., personal digital assistant (PDA) or smart phone), server (e.g., blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components.

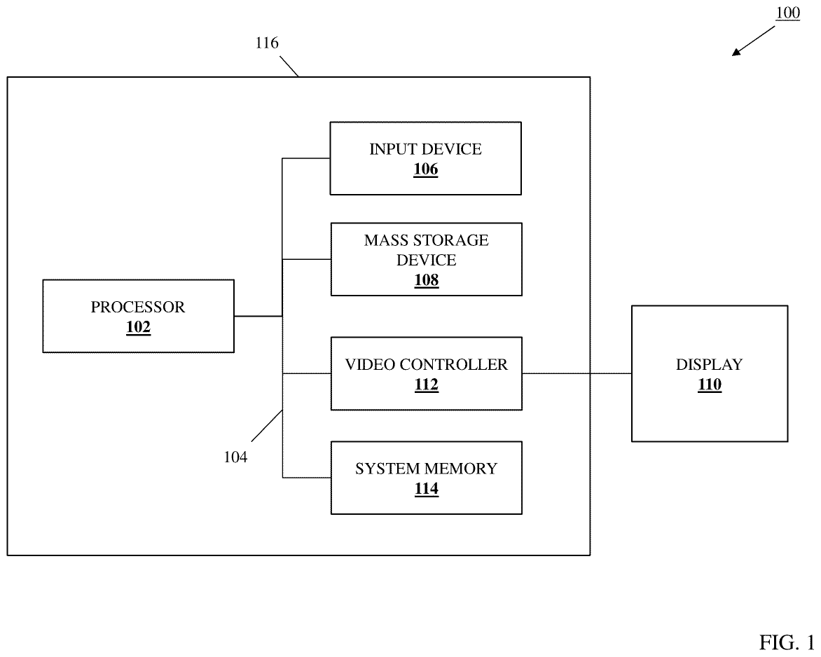

In one embodiment, IHS 100, FIG. 1, includes a processor 102, which is connected to a bus 104. Bus 104 serves as a connection between processor 102 and other components of IHS 100. An input device 106 is coupled to processor 102 to provide input to processor 102. Examples of input devices may include keyboards, touchscreens, pointing devices such as mouses, trackballs, and trackpads, and/or a variety of other input devices known in the art. Programs and data are stored on a mass storage device 108, which is coupled to processor 102. Examples of mass storage devices may include hard discs, optical disks, magneto-optical discs, solid-state storage devices, and/or a variety of other mass storage devices known in the art. IHS 100 further includes a display 110, which is coupled to processor 102 by a video controller 112. A system memory 114 is coupled to processor 102 to provide the processor with fast storage to facilitate execution of computer programs by processor 102. Examples of system memory may include random access memory (RAM) devices such as dynamic RAM (DRAM), synchronous DRAM (SDRAM), solid state memory devices, and/or a variety of other memory devices known in the art. In an embodiment, a chassis 116 houses some or all of the components of IHS 100. It should be understood that other buses and intermediate circuits can be deployed between the components described above and processor 102 to facilitate interconnection between the components and the processor 102.

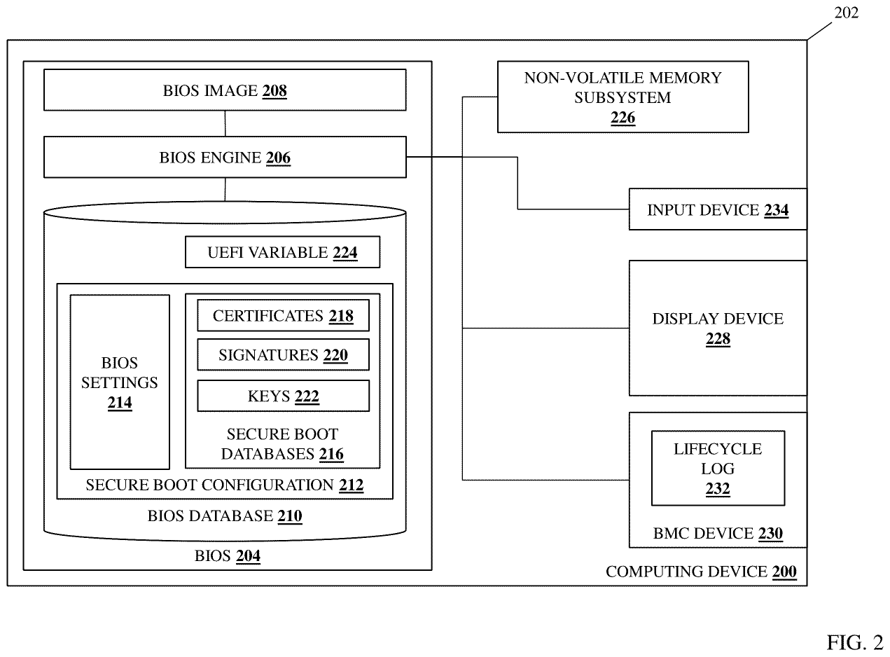

Referring now to FIG. 2, an embodiment of a computing device 200 is illustrated that may provide the BIOS secure boot configuration modification source reporting system of the present disclosure. In an embodiment, the computing device 200 may be provided by the IHS 100 discussed above with reference to FIG. 1, and/or may include some or all of the components of the IHS 100, and in specific examples may be provided by a server device. However, while illustrated and discussed as being provided by a server device, one of skill in the art in possession of the present disclosure will recognize that computing devices provided in the BIOS secure boot configuration modification source reporting system of the present disclosure may include laptop/notebook computing devices, desktop computing devices, tablet computing devices, mobile phones, networking devices (e.g., switch devices), storage systems, and/or any other computing devices that include a BIOS that may be configured with a secure boot configuration and operate similarly as the computing device 200 discussed below.

In the illustrated embodiment, the computing device 200 includes a chassis 202 that houses the components of the computing device 200, only some of which are illustrated and described below. For example, the chassis 202 may house a BIOS processing system (not illustrated, but which may be provided by BIOS processing firmware) and a BIOS memory system (not illustrated, but which may be provided by BIOS memory firmware such as, for example, a Serial Peripheral Interface (SPI) memory device) that is coupled to the BIOS processing system and that includes instructions that, when executed by the BIOS processing system, cause the BIOS processing system to provide a BIOS 204 that is configured to perform the functionality of the BIOS and/or computing devices discussed below. However, while illustrated and described as a “BIOS”, one of skill in the art in possession of the present disclosure will appreciate how the BIOS 204 and/or its components may be provided according to the UEFI specification that defines an architecture for firmware used to initialize computing device hardware and an interface for interacting with an operating system.

For example, the BIOS 204 may include a BIOS engine 206 that is configured to perform the any of the BIOS secure boot configuration modification reporting functionality that is described as being performed by the BIOS engines, BIOS subsystems, and/or BIOS described below. Furthermore, the BIOS 204 may also include a BIOS image 208 that includes a BIOS firmware volume and/or other data structures that store BIOS code and other BIOS information that is used by the BIOS processing system discussed above to provide the BIOS 204. As discussed below and as will be appreciated by one of skill in the art in possession of the present disclosure, the BIOS image 208 may be provided with BIOS updates that may be authenticated before they are performed to update the BIOS 204 as described below. Further still, the BIOS 204 may also include a BIOS storage subsystem (not illustrated, but which may be provided by BIOS storage firmware such as, for example, the SPI memory device discussed above) that is coupled to the BIOS engine 206 (e.g., via a coupling between the BIOS storage subsystem and the BIOS processing system) and that is configured to provide a BIOS database 210 that may store any of the information used by the BIOS engine 206 as described below.

In the illustrated example, the BIOS database 210 stores a secure boot configuration 212 that includes a plurality of BIOS settings 214, as well as a plurality of secure boot databases 216. To provide a specific example, the plurality of secure boot databases 216 may be provided by a signature database (also called a “DB” database), a revoked signatures database (also called a “DBX” database), a Key Exchange Key (KEK) database, a Platform Key (PK) database, a timestamp database (also called a “DBT” database), and/or any other databases that would be apparent to one of skill in the art in possession of the present disclosure, any of which may be provided by secure boot Unified Extensible Firmware Interface (UEFI) variables and/or using other database provisioning techniques that would be apparent to one of skill in the art in possession of the present disclosure. As illustrated in FIG. 2, any of the secure boot databases 216 may store certificates 218, signatures 220 (e.g., which may be provided by hash values or other signatures known in the art), keys 222, and/or other secure boot database information that would be apparent to one of skill in the art in possession of the present disclosure.

The computing device 200 also includes secure boot configuration modification source identifier storage that, in the examples illustrated and described below, is provided by a UEFI variable 224 that is included in the BIOS database 210 and provided outside of or otherwise separate from the secure boot configuration 212, and one of skill in the art in possession of the present disclosure will appreciate how a UEFI variable may be configured to store a secure boot configuration modification source identifier such as the flag or bit discussed below, secure boot configuration modification source identifier bitmaps that include the bits described below, and/or other secure boot configuration modification source identifier information that would be apparent to one of skill in the art in possession of the present disclosure. Furthermore, while illustrated and described as being provided by a UEFI variable, one of skill in the art in possession of the present disclosure will recognize how a secure boot configuration modification source identifier storage may be provided by other storage and/or non-volatile memory subsystems in the computing device 200 while remaining within the scope of the present disclosure as well.

The chassis 202 also houses a non-volatile memory subsystem 226 that is illustrated and described as being coupled to the BIOS engine 206 in the BIOS 204 (e.g., via a coupling between the non-volatile memory subsystem 226 and the BIOS processing firmware discussed above), and while the non-volatile memory subsystem 226 is illustrated and discussed as being separate from the BIOS 204 (e.g., the non-volatile memory subsystem 226 may be provided by any non-volatile memory device housed in or coupled to the computing device 200), one of skill in the art in possession of the present disclosure will appreciate how the non-volatile memory subsystem 226 may be included in the BIOS 204 (e.g., the non-volatile memory subsystem 226 may be included in the SPI memory device discussed above) while remaining within the scope of the present disclosure as well.

In the illustrated embodiment, the chassis 202 also houses a display device 228 that is coupled to the BIOS engine 206 in the BIOS 204 (e.g., via a coupling between the display device 228 and the BIOS processing firmware discussed above), and while the display device 228 is illustrated and described as being housed in the chassis 202 (e.g., the display device 228 may be provided in a laptop/notebook computing device), the display device 228 may be coupled to the computing device 200 (e.g., the display device 228 may be an external display device coupled to a desktop computing device or as part of a separate management computing device that is coupled to a server device) while remaining within the scope of the present disclosure as well. As illustrated, the chassis 202 may also house a Baseboard Management Controller (BMC) device 230 that is coupled to the BIOS engine 206 in the BIOS 204 (e.g., via a coupling between the BMC device 230 and the BIOS processing system discussed above), and that includes a lifecycle log 232.

As will be appreciated by one of skill in the art in possession of the present disclosure, the BMC device 230 may be provided by an integrated DELL® Remote Access Controller (iDRAC) included in server devices available from DELL® Inc. of Round Rock, Texas, United States, and thus may be configured to provide Out-Of-Band (OOB) management for the computing device 200 using mostly separate resources from the computing device 200 in order to provide a browser-based interface or Command-Line Interface (CLI) for managing and monitoring hardware in the computing device 200 (e.g., the BMC device 230 may be configured to manage the BIOS updates discussed above that may be provided in the BIOS image 208).

In the illustrated embodiment, the chassis 202 also houses an input device 234 that is coupled to the BIOS engine 206 in the BIOS 204 (e.g., via a coupling between the input device 234 and the BIOS processing system discussed above), and while the input device 234 is described in some of the examples below as being provided by a keyboard device, one of skill in the art in possession of the present disclosure will appreciate how other input devices (e.g., a Universal Serial Bus (USB) storage device) will fall within the scope of the present disclosure as well. However, while a specific computing device 200 has been illustrated and described, one of skill in the art in possession of the present disclosure will recognize that computing devices (or other devices operating according to the teachings of the present disclosure in a manner similar to that described below for the computing device 200) may include a variety of components and/or component configurations for providing conventional computing device functionality, as well as the BIOS secure boot configuration modification source reporting functionality discussed below, while remaining within the scope of the present disclosure as well.

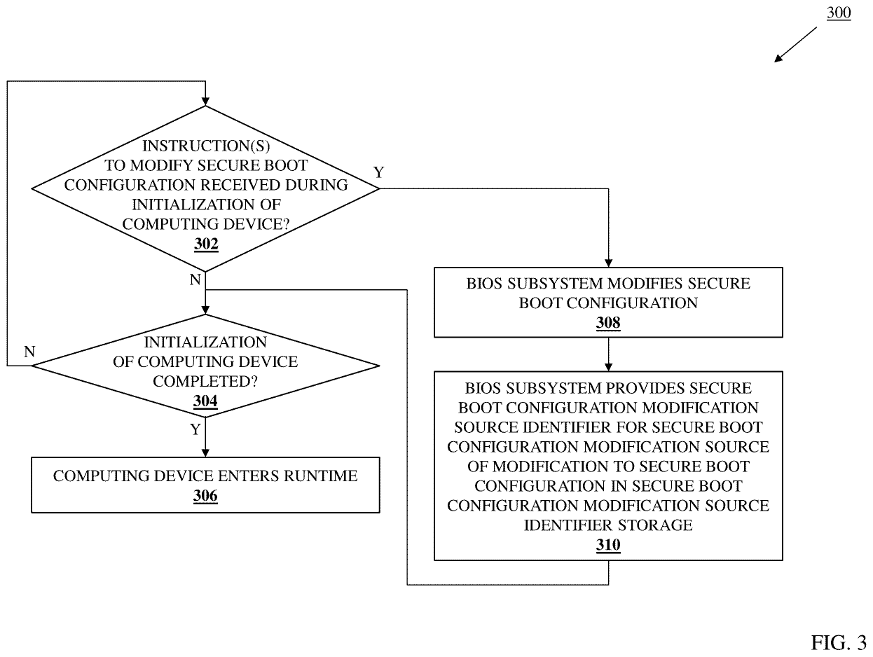

Referring now to FIG. 3, an embodiment of a method 300 for recording a source of modifications to a secure boot configuration in a Basic Input Output System (BIOS) is illustrated. As discussed below, the systems and methods of the present disclosure may identify and store the source of a modification to a secure boot configuration in a BIOS during a current initialization of a computing device. For example, the BIOS secure boot configuration modification source reporting system of the present disclosure may include a computing device housing a BIOS that is coupled to a non-volatile memory subsystem and that includes a BIOS subsystem coupled to a BIOS database storing a secure boot configuration, and to a secure boot configuration modification source identifier storage. The BIOS subsystem receives first instruction(s) to modify the secure boot configuration from a first secure boot configuration modification source and, based on the first instruction(s), modifies the secure boot configuration and provides a first secure boot configuration modification source identifier for the first secure boot configuration modification source in the secure boot configuration modification source identifier storage. As discussed below, the recording of the secure boot configuration modification source during the method 300 allows secure boot configuration modification source(s) to be identified to users during a subsequent initialization of the computing device in order to reduce customer support calls and related issues with conventional secure boot configuration modification systems discussed above.

The method 300 begins at decision block 302 where the method 300 proceeds depending on whether one or more instructions to modify a secure boot configuration are received during initialization of a computing device. In an embodiment, at decision block 302, the computing device 200 may be powered on, booted, reset, rebooted, and/or otherwise initialized and, in response, the BIOS 204 may begin initialization of the computing device 200. As discussed in further detail below with reference to the method 700, the initialization of the computing device 200 may include detecting whether any modifications have been made to the secure boot configuration 212 and, if so, generating secure boot configuration modification source identification message(s) while, if not, completing the initialization of the computing device 200. As such, one of skill in the art in possession of the present disclosure will appreciate how both of the methods 300 and 700 may be performed as part of any particular initialization of the computing device 200.

As will be appreciated by one of skill in the art in possession of the present disclosure, in an embodiment of decision block 302 and during the initialization of the computing device 200, the BIOS engine 206 may receive instructions to modify the secure book configuration 212. In some of the specific examples provided below, the instructions to modify the secure boot configuration are described as being provided to the BIOS engine 206 as part of a BIOS update that may be provided in the BIOS image 208 (e.g., a BIOS update provided in the BIOS image 208 via the BMC device 230), via the input device 234 (e.g., a USB storage device), via a computing device manufacturer software update, and/or via using any of a variety of other BIOS update techniques that would be apparent to one of skill in the art in possession of the present disclosure. In others of the specific examples provided below, the instructions to modify the secure boot configuration are described as being provided to the BIOS engine 206 as part of a BIOS setup initiated via the input device 234 (e.g., via a user selecting an “F2” key on a keyboard device). In others of the specific examples provided below, the instructions to modify the secure boot configuration are described as being provided to the BIOS engine 206 via a Graphical User Interface (GUI) provided by the BMC device 230. In others of the specific examples provided below, the instructions to modify the secure boot configuration are described as being provided to the BIOS engine 206 via a personality module (also called an IDentity Module (IDM)) that was installed on the computing device 200 via the BMC device 230.

In others of the specific examples provided below, the instructions to modify the secure boot configuration are described as being provided to the BIOS engine 206 via the importation of secure boot certificates via an Out-Of-Band (OOB) subsystem such as a Remote Access Controller ADMinistrator (RACADM) tool or a REDFISH tool. In others of the specific examples provided below, the instructions to modify the secure boot configuration are described as being provided to the BIOS engine 206 via an update to a secure boot databases 216 (e.g., an update to a signature database (also called a “DB” database), a revoked signatures database (also called a “DBX” database), a Key Exchange Key (KEK) database, a Platform Key (PK) database, a timestamp database (also called a “DBT” database), and/or any other secure boot databases that would be apparent to one of skill in the art in possession of the present disclosure). However, while several specific examples of the provisioning of instructions to modify the secure boot configuration are provided herein, one of skill in the art in possession of the present disclosure will appreciate how secure boot configuration modification instructions may be provide in a variety of other manners while remaining within the scope of the present disclosure as well.

As such, at decision block 302, the method 300 may proceed depending on whether the BIOS engine 206 in the BIOS 204 has received secure boot configuration modification instructions during the initialization of the computing device 200. If, at decision block 302, no instructions to modify the secure boot configuration are received during initialization of the computing device, the method 300 proceeds to decision block 304 where the method 300 proceeds depending on whether the initialization of the computing device has completed. As will be appreciated by one of skill in the art in possession of the present disclosure, the initialization of the computing device 200 will eventually be completed by the BIOS 204 and, as such, the method 300 may proceed at decision block 304 depending on whether that initialization has been completed. If, at decision block 304, the initialization of the computing device has not completed, the method 300 returns to decision block 302 such that the method 300 loops and proceeds depending on whether a secure boot configuration modification instruction is received before the initialization of the computing device 200 is completed. If, at decision block 304, the initialization of the computing device has completed, the method 300 proceeds to block 306 where the computing device enters runtime. As such, one of skill in the art in possession of the present disclosure will appreciate how, in an embodiment of block 306, the BIOS 204 may load an operating system for the computing device 200 and allow the computing device 200 to begin runtime operations in which the operating system controls the computing device 200.

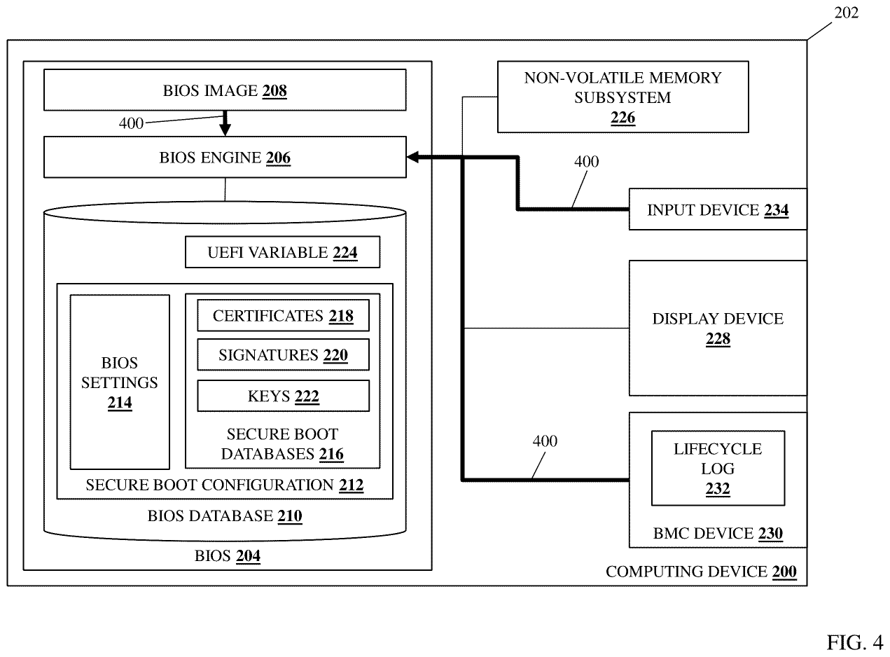

If, at decision block 302, one or more instructions to modify the secure boot configuration are received during initialization of the computing device, the method 300 proceeds to block 308 where the BIOS subsystem modifies the secure boot configuration. With reference to FIG. 4, in an embodiment of decision block 302 and as discussed above, the BIOS engine 206 may perform secure boot configuration modification instruction receiving operations 400 that include receiving instructions to modify the secure book configuration 212, which are illustrated in FIG. 4 as being received from any one of, each of, or any combination of the BIOS image 208, the input device 234, and the BMC device 230.

As discussed above, the instructions to modify the secure boot configuration during the initialization of the computing device 200 may be provided to the BIOS engine 206 as part of a BIOS update that may be provided in the BIOS image 208 (e.g., a BIOS update provided in the BIOS image 208 via the BMC device 230), via the input device 234 (e.g., a USB storage device), via a computing device manufacturer software update, and/or via using any of a variety of other BIOS update techniques that would be apparent to one of skill in the art in possession of the present disclosure, as part of a BIOS setup initiated via the input device 234 (e.g., via a user selecting an “F2” key on a keyboard device), via a GUI provided by the BMC device 230, via a personality module (also called an IDM) that was installed on the computing device 200 via the BMC device 230, via the importation of secure boot certificates via an OOB subsystem such as a RACADM tool or a REDFISH tool, via an update to a secure boot databases 216, and/or via a variety of other secure boot configuration modification instruction provisioning techniques that would be apparent to one of skill in the art in possession of the present disclosure.

As such, while FIG. 4 illustrates the instructions to modify the secure boot configuration 212 as being received from the BIOS image 208, the input device 234, and the BMC device 230, one of skill in the art in possession of the present disclosure will appreciate how the instructions to modify the secure boot configuration 212 may be received from any one of (or any combination of) the BIOS image 208, the input device 234, and the BMC device 230, as well as other sources of secure boot configuration modification instructions that would be apparent to one of skill in the art in possession of the present disclosure.

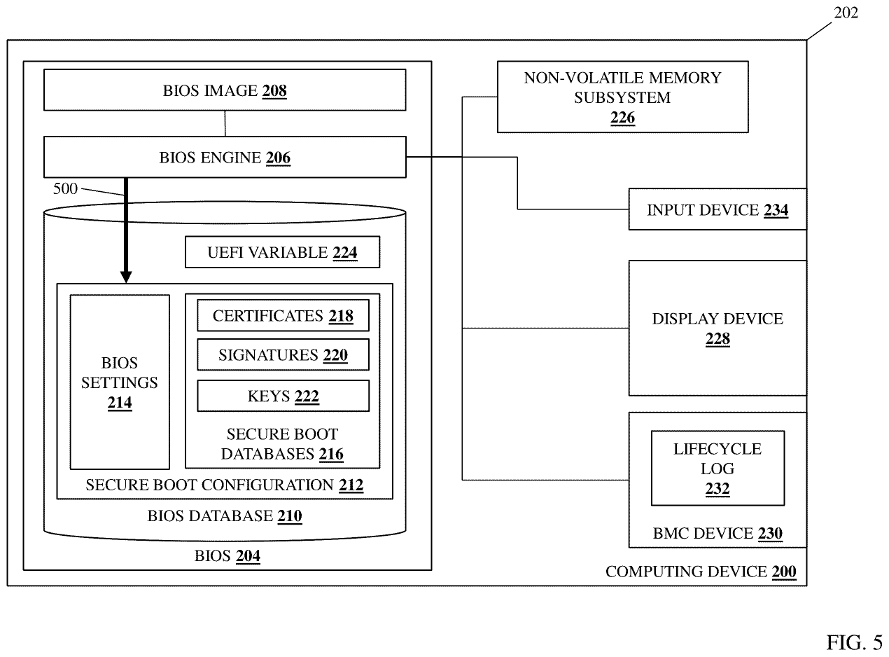

With reference to FIG. 5, in an embodiment of block 308, the BIOS engine 206 in the BIOS 204 may perform secure boot configuration modification operations 500 that include modifying the secure boot configuration 212, which one of skill in the art in possession of the present disclosure will appreciate may include providing modification(s) to the BIOS settings 214, providing modification(s) to the secure boot databases 216 (e.g., providing modifications to the certificates 218, the signatures 220, and/or the keys 222), and/or providing modification(s) to any other information included in the secure boot configuration 212. As such, one of skill in the art in possession of the present disclosure will appreciate how the secure boot configuration modification operations 500 may provide for the addition to, removal of, and/or replacement of any of any of the information stored in the BIOS settings 214; the addition to, removal of, and/or replacement of any of the certificates 218 the signatures 220, and/or the keys 222 included in the secure boot databases 216; and/or the addition to, removal of, and/or replacement of any other information included in the secure boot configuration 212.

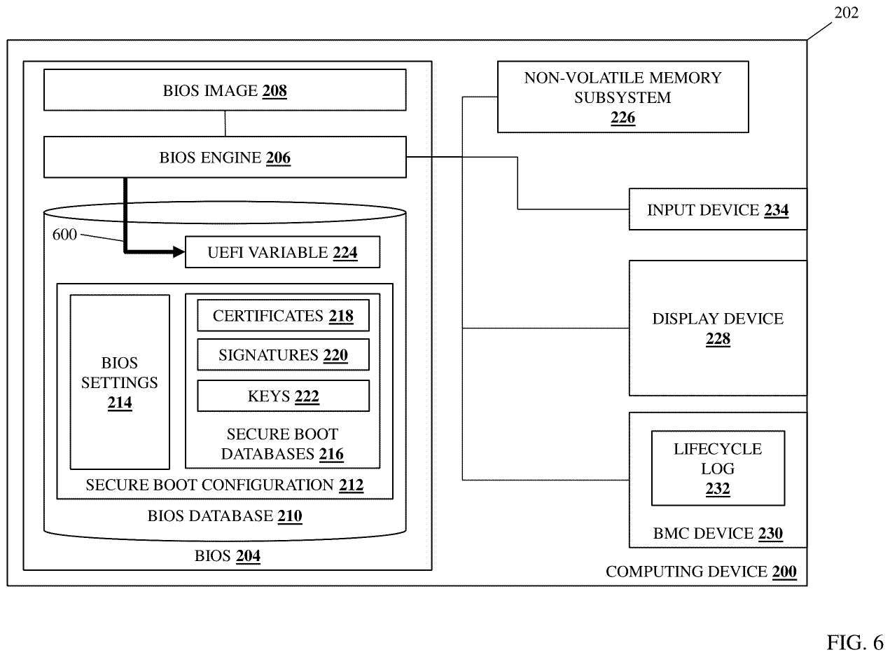

The method 300 then proceeds to block 310 where the BIOS subsystem provides a secure boot configuration modification source identifier for a secure boot configuration modification source of the modification to the secure boot configuration in a secure boot configuration modification source identifier storage. With reference to FIG. 6, in an embodiment of block 310 and in response to modifying the secure boot configuration 212 at block 308, the BIOS engine 206 in the BIOS 204 may perform secure boot configuration modification source identifier provisioning operations 600 that, in the illustrated example, include providing a secure boot configuration modification source identifier in the UEFI variable 224 that provides the secure boot configuration modification source identifier storage of the illustrated embodiments as described above.

To provide a specific example of the secure boot configuration modification source identifier provisioning operations 600, the provisioning of the secure boot configuration modification source identifier may be performed as part of the execution of BIOS code by the BIOS engine 206 that provides the modification(s) to the secure boot configuration 212. For example, as will be appreciated by one of skill in the art in possession of the present disclosure, the modification(s) to the secure boot configuration 212 may require the BIOS engine 206 to perform one or more function calls that conclude with the secure boot configuration 212 being modified as described above. As such, the BIOS code that provides the function calls that result in the modification(s) to the secure boot configuration instructed by any particular secure boot configuration modification source may end with BIOS code that instructs the BIOS engine 206 to write or otherwise provide a secure boot configuration modification source identifier for that secure boot configuration modification source in the UEFI variable 224 that provides the secure boot configuration modification source identifier storage in the illustrated embodiments.

To provide a specific example, the secure boot configuration modification source identifiers provided in the UEFI variable 224 at block 310 may be provided according to the secure boot configuration modification source identifier table below:

| SOURCE | | |
|---|---|---|
| IDENTI- | | |
| FIER | SOURCE INFORMATION | ACTION |
| 0 | NON-OEM RUNTIME MODIFICATION | ALERT USER |
| 1 | BIOS-IMAGE-INITIATED | INFORM USER |
| | MODIFICATION | |
| 2 | BMC-INITIATED MODIFICATION | INFORM USER |
| 3 | PERSONALITY-MODULE-INITIATED | INFORM USER |
| | MODIFICATION | |
| 4 | INPUT-DEVICE-INITIATED | INFORM USER |
| | MODIFICATION | |
| 5 | NON-BMC OOB-INITIATED | INFORM USER |
| | MODIFICATION | |
| 6 | SAVED FOR FUTURE USE | TBD |

As will be appreciated by one of skill in the art in possession of the present disclosure, the secure boot configuration modification source identifier table above includes a plurality of rows, with each row associating a respective secure boot configuration modification “SOURCE IDENTIFIER” with respective “SOURCE INFORMATION” identifying a secure boot configuration modification source, and a respective “ACTION” to perform in response to a modification to the secure boot configuration by that secure boot configuration modification source.

As such, for BIOS-image-initiated modifications to the secure boot configuration 212 the secure boot configuration modification source identifier table provides a secure boot configuration modification source identifier “1” and an action to “INFORM USER”, for BMC-initiated modifications to the secure boot configuration 212 the secure boot configuration modification source identifier table provides a secure boot configuration modification source identifier “2” and an action to “INFORM USER”, for personality-module-initiated modifications to the secure boot configuration 212 the secure boot configuration modification source identifier table provides a secure boot configuration modification source identifier “3” and an action to “INFORM USER”, for input-device-initiated modifications to the secure boot configuration 212 the secure boot configuration modification source identifier table provides a secure boot configuration modification source identifier “4” and an action to “INFORM USER”, and for non-BMC OOB-initiated modifications to the secure boot configuration 212 the secure boot configuration modification source identifier table provides a secure boot configuration modification source identifier “5” and an action to “INFORM USER”.

As discussed in further detail below, the embodiments of the secure boot configuration modification source identifier table provided herein includes a default secure boot configuration modification source identifier “0” that identifies non-Original Equipment Manufacturer (OEM)-initiated runtime modifications to the secure boot configuration 212 as well as an associated action “ALERT USER”. For example, the UEFI variable 224 may be set to the default secure boot configuration modification source identifier “0” prior to the initialization of the computing device 200 that is performed during the method 300, and may then only be changed when the secure boot configuration 212 is modified during the initialization of the computing device 200 at block 308 (e.g., the default secure boot configuration modification source identifier “0” may be overwritten or erased during any performance of block 310), which as described below allows a user to be alerted when modification(s) performed on the secure boot configuration 212 during runtime of the computing device 200 are initiated by a non-OEM source.

Furthermore, the embodiments of the secure boot configuration modification source identifier table provided herein may also reserve secure boot configuration modification source identifier(s) (e.g. the secure boot configuration modification source identifier “6”) for future use. However, while a specific example of secure boot configuration modification identifiers has been described with regard to the secure boot configuration modification identifier table discussed above, one of skill in the art in possession of the present disclosure will appreciate how secure boot configuration modification identifiers may be provided in a variety of manners that will fall within the scope of the present disclosure as well.

Thus, continuing with the specific examples provided above, a secure boot configuration modification performed in response to instructions provided to the BIOS engine 206 as part of a BIOS update in the BIOS image 208 may result in the BIOS engine 206 providing the secure boot configuration modification source identifier “1” in the UEFI variable 224 as part of its execution of BIOS code that provides that secure boot configuration modification. Similarly, a secure boot configuration modification performed in response to instructions provided to the BIOS engine 206 as part of a BIOS update via the input device 234 (e.g., a USB storage device) may result in the BIOS engine 206 providing the secure boot configuration modification source identifier “4” in the UEFI variable 224 as part of its execution of BIOS code that provides that secure boot configuration modification.

Similarly, a secure boot configuration modification performed in response to instructions provided to the BIOS engine 206 as part of a BIOS settings modification performed via the input device 234 (e.g., via a user selecting an “F2” key on a keyboard device to modify the BIOS settings 214) may result in the BIOS engine 206 providing the secure boot configuration modification source identifier “4” in the UEFI variable 224 as part of its execution of BIOS code that provides that secure boot configuration modification.

Similarly, a secure boot configuration modification performed in response to instructions provided via a GUI provided by the BMC device 230 may result in the BIOS engine 206 providing the secure boot configuration modification source identifier “2” in the UEFI variable 224 as part of its execution of BIOS code that provides that secure boot configuration modification. Similarly, a secure boot configuration modification performed in response to instructions provided via a personality module may result in the BIOS engine 206 providing the secure boot configuration modification source identifier “3” in the UEFI variable 224 as part of its execution of BIOS code that provides that secure boot configuration modification. Similarly, a secure boot configuration modification performed in response to instructions provided via the importation of secure boot certificates using an OOB subsystem such as a RACADM tool or a REDFISH tool may result in the BIOS engine 206 providing the secure boot configuration modification source identifier “5” in the UEFI variable 224 as part of its execution of BIOS code that provides that secure boot configuration modification.

As will be appreciated by one of skill in the art in possession of the present disclosure, in some embodiments the modification of the secure boot configuration modification source identifier may only be allowed during initialization of the computing device 200 and thus may be prevented during runtime of the computing device 200. To provide a specific example, the UEFI variable 224 may only be allowed in an “EFI_BOOT_SERVICES” environment, thus preventing runtime modifications to the UEFI variable 224 (i.e., as the “EFI_BOOT_SERVICES” environment is not present once the operating system has been provided on the computing device 200 to allow the computing device to enter runtime), although other techniques for preventing runtime modifications to secure boot configuration modification source identifier(s) will fall within the scope of the present disclosure as well.

The method 300 then proceeds to decision block 304 where the method 300 proceeds depending on whether the initialization of the computing device has completed substantially as described above. As such, the method 300 may loop such that, during the initialization of the computing device 200, the BIOS engine 206 modifies the secure boot configuration 212 in response to instruction(s) from secure boot configuration modification source(s) until the initialization of the computing device 200 is completed. As such, one of skill in the art in possession of the present disclosure will appreciate how the UEFI variable 224 may be configured to store a plurality of the secure boot configuration modification source identifiers via, for example, a bitmap and/or other bit-storage data structures known in the art in order to cover situations in which the secure boot configuration 212 is modified multiple times during a single initialization of the computing device 200 by different secure boot configuration modification sources. However, one of skill in the art in possession of the present disclosure will also appreciate how UEFI variables or other secure boot configuration modification source identifier storage subsystems may be configured to store a flag, a single bit, multiple flags, or other information providing the secure boot configuration modification source identifier(s) of the present disclosure while remaining within the scope of the present disclosure as well.

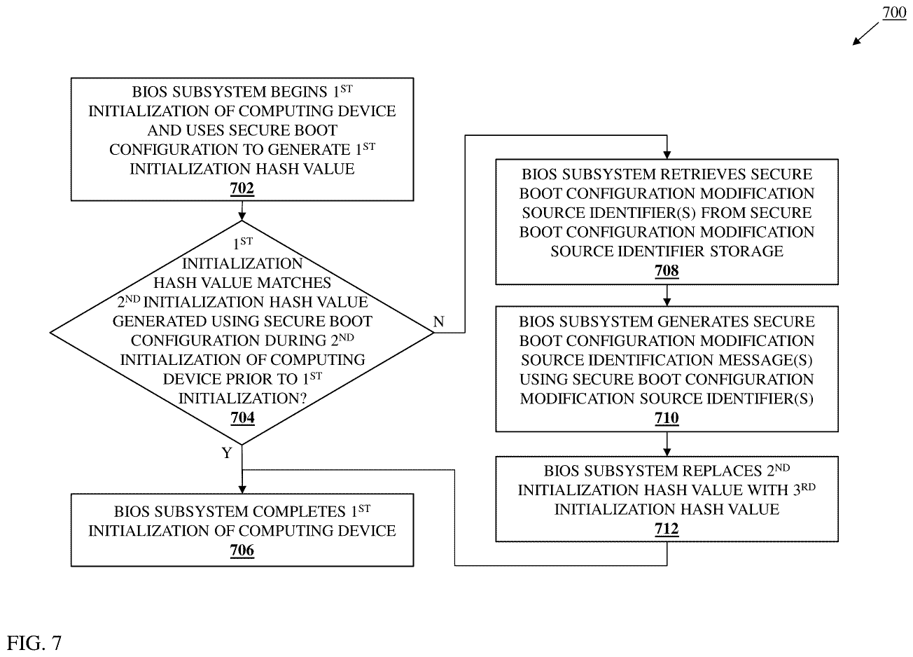

Referring now to FIG. 7, an embodiment of a method 700 for reporting a source of modifications to a secure boot configuration in a Basic Input Output System (BIOS) is illustrated. As discussed below, the systems and methods of the present disclosure may identify the source of a modification to a secure boot configuration in a BIOS of a computing device, which was performed during a previous initialization of that computing device, during a current initialization of that computing device. For example, the BIOS secure boot configuration modification source reporting system of the present disclosure may include a computing device housing a BIOS that is coupled to a non-volatile memory subsystem and that includes a BIOS subsystem coupled to a BIOS database storing a secure boot configuration, and to a secure boot configuration modification source identifier storage. During a current initialization of the computing device, the BIOS subsystem uses the secure boot configuration to generate a current initialization hash value, determines that the current initialization hash value does not match a previous initialization hash value that is stored in the non-volatile memory subsystem and that was generated using the secure boot configuration during a previous initialization of the computing device and, in response, retrieves secure boot configuration modification source identifier(s) from the secure boot configuration modification source identifier storage and uses them to generate secure boot configuration modification source identification message(s). As such, modifications to secure boot configuration may be identified to users while reducing customer support calls and related issues with conventional secure boot configuration modifications systems discussed above.

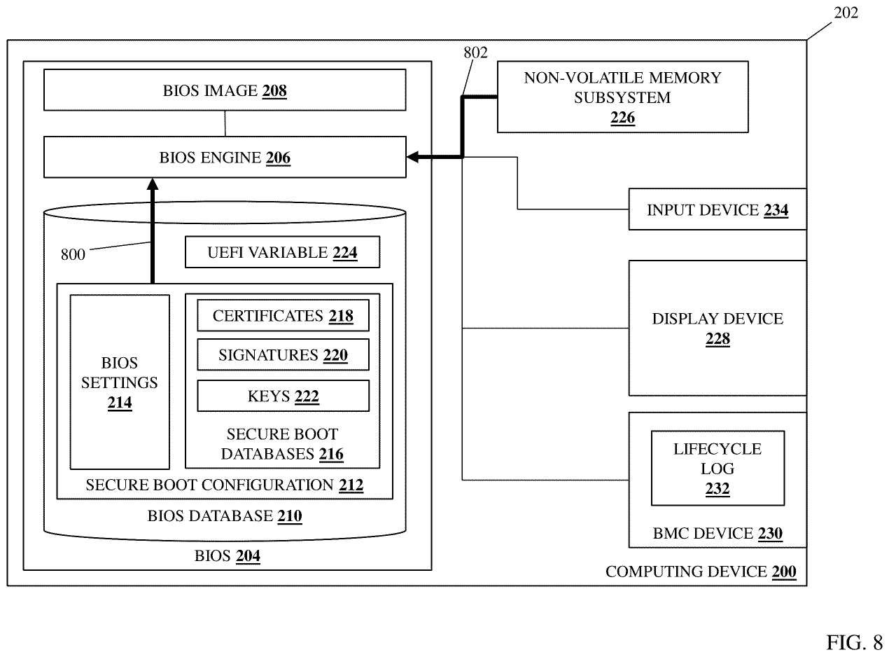

The method 700 begins at block 702 where a BIOS subsystem begins a first initialization of a computing device and uses a secure boot configuration to generate a first initialization hash value. In an embodiment, at block 702, the computing device 200 may be powered on, booted, reset, rebooted, and/or otherwise initialized and, in response, the BIOS 204 may begin a “current” initialization of the computing device 200. With reference to FIG. 8, in an embodiment of block 802 and as part of the “current” initialization of the computing device 200, the BIOS engine 206 in the BIOS 204 may perform initialization hash value generation operations 800 that may include performing a hashing operation (e.g., a SHA hashing operation and/or other hashing operations known in the art) using information stored in the secure boot configuration 212 to generate a “current” initialization hash value for the secure boot configuration 212 during that “current” initialization of the computing device 200 (the “first” initialization hash value discussed above). As such, one of skill in the art in possession of the present disclosure will appreciate how the “current” initialization hash value for the secure boot configuration 212 during the “current” initialization of the computing device 200 may be generated using information in the BIOS settings 214; the certificates 218, signatures 220, and keys 222 in the secure boot databases 216; and/or any other information that one of skill in the art in possession of the present disclosure will recognize may be included in the secure boot configuration 212.

The method 700 then proceeds to decision block 704 where the method 700 proceeds depending on whether the first initialization hash value matches a second initialization hash value that was generated during a second initialization of the computing device that occurred prior to the first initialization. As will be appreciated by one of skill in the art in possession of the present disclosure, the hashing operation used to generate the “current”/first initialization hash value and the “previous”/second hash value discussed above will produce identical hash values when performed using identical information in the secure boot configuration 212 (i.e., when the information in the BIOS settings 214; the certificates 218, signatures 220, and keys 222 in the secure boot databases 216; and/or any other information included in the secure boot configuration 212 has not been modified between the “previous” initialization and the “current” initialization of the computing device 200).

As such, one of skill in the art in possession of the present disclosure will also appreciate how the hashing operation used to generate the “current”/first initialization hash value and the “previous”/second hash value discussed above will produce different hash values when performed using different information in the secure boot configuration 212 (i.e., when the information in the BIOS settings 214; the certificates 218, signatures 220, and keys 222 in the secure boot databases 216; and/or any other information included in the secure boot configuration 212 has been modified between the “previous” initialization and the “current” initialization of the computing device 200). As such, with continued reference to FIG. 8, in an embodiment of decision block 704, the BIOS engine 206 in the BIOS 204 may perform initialization hash value comparison operations 802 that include retrieving the “previous” initialization hash value from the non-volatile memory subsystem 224, and comparing the “current” initialization hash value to that “previous” initialization hash value. However, while the use of hash values to detect changes in the secure boot configuration have been described, one of skill in the art in possession of the present disclosure will appreciate how other techniques for detecting changes in the secure boot configuration will fall within the scope of the present disclosure as well.

If, at decision block 704, the first initialization hash value matches the second initialization hash value, the method 700 proceeds to block 706 where the BIOS subsystem completes the first initialization of the computing device. In an embodiment, at block 706, the BIOS 204 may complete the “current” initialization of the computing device 200, and one of skill in the art in possession of the present disclosure will appreciate how the “completion” of the “current” initialization of the computing device 200 may include loading an operating system for the computing device 200 and allowing the computing device 200 to begin runtime operations in which the operating system controls the computing device 200.

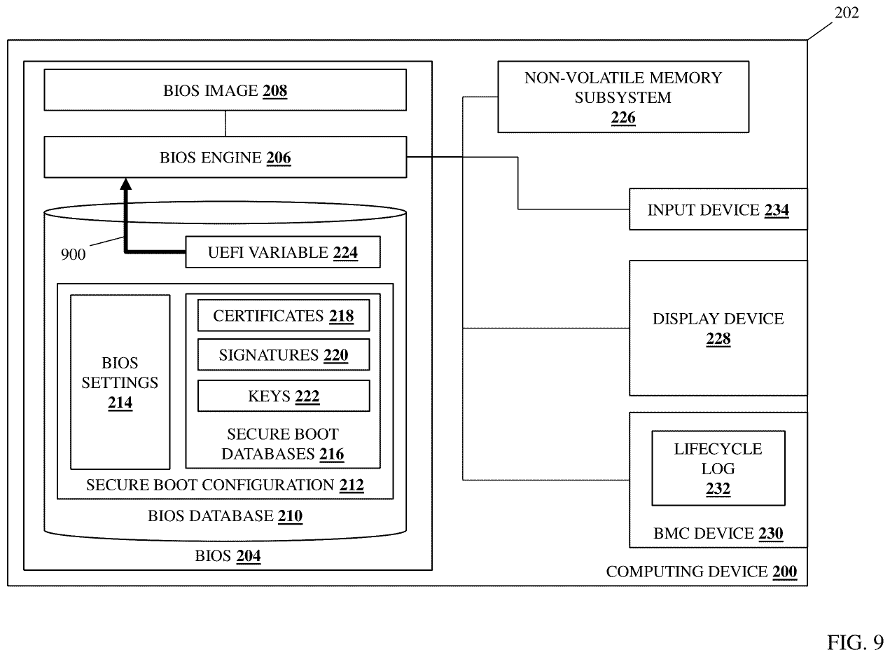

If, at decision block 706, the first initialization hash value does not match the second initialization hash value, the method 700 proceeds to block 708 where the BIOS subsystem retrieves one or more secure boot configuration modification source identifiers from a secure boot configuration modification source identifier storage. With reference to FIG. 9, in an embodiment of block 708, the BIOS engine 206 in the BIOS 204 may perform secure boot configuration modification source identifier retrieval operations 900 that include retrieving secure boot configuration modification source identifier(s) from the UEFI variable 224 that provides the secure boot configuration modification source identifier storage in the embodiments illustrated and described herein, and as discussed above the secure boot configuration modification source identifier(s) from the UEFI variable 224 may include a default secure boot configuration modification source identifier, a secure boot configuration modification source identifier provided according to the method 300 discussed above, or a plurality of secure boot configuration modification source identifiers (e.g., via the bitmap) provided according to the method 300 discussed above. However, while specific examples have been provided, one of skill in the art in possession of the present disclosure will appreciate how a secure boot configuration modification source identifiers may be retrieved in a variety of manners that will fall within the scope of the present disclosure.

The method 700 then proceeds to block 710 where the BIOS subsystem generates one or more secure boot configuration modification source identification messages using the one or more secure boot configuration modification source identifiers. In an embodiment, at block 710, the BIOS engine 208 in the BIOS 204 may perform secure boot configuration modification message generation operations 1000 that may include generating a secure boot configuration modification source identification message based on the secure boot configuration modification source identifier(s) retrieved at block 708, with that secure boot configuration modification source identification message displayed on the display device 226, provided in the lifecycle log 230 included in the BMC device 228, and/or transmitted to a network administrator or other user using any techniques that would be apparent to one of skill in the art in possession of the present disclosure.

Thus, continuing with the specific examples provided above, a secure boot configuration modification source identification message generated at block 710 may be based on the secure boot configuration modification source identifier “1” discussed above and may inform the user of the modification to the secure boot configuration 212, the secure boot configuration modification source of that modification, and or any other secure boot configuration modification information that would be apparent to one of skill in the art in possession of the present disclosure (e.g., “The secure boot configuration has been modified as part of a BIOS update initiated via the BIOS image”). In some embodiments, the secure boot configuration modification source identification message may be generated according to the action (e.g., “INFORM USER”) associated with the secure boot configuration modification source identifier “1” (e.g., the secure boot configuration modification source identifier message above may include an informational message (“The BIOS update was initiated via the BIOS image in an authenticated process”) that is intended to inform the user of the modification to the secure boot configuration without alarming the user.

Similarly, a secure boot configuration modification source identification message generated at block 710 may be based on the secure boot configuration modification source identifier “4” discussed above and may identify the modification to the secure boot configuration 212, the secure boot configuration modification source of that modification, and or any other secure boot configuration modification information that would be apparent to one of skill in the art in possession of the present disclosure (e.g., “The secure boot configuration has been modified as part of a BIOS update initiated via a USB storage device” or “The secure boot configuration has been modified as part of a BIOS settings change initiated via a keyboard F2 instruction”). In some embodiments, the secure boot configuration modification source identification message may be generated according to the action (e.g., “INFORM USER”) associated with the secure boot configuration modification source identifier “4” (e.g., the secure boot configuration modification source identifier message above may include an informational message (“The BIOS update was initiated via the USB storage device in an authenticated process”, or “The BIOS update was initiated via the a keyboard F2 instruction in an authenticated process”) that is intended to inform the user of the modification to the secure boot configuration without alarming the user.

However, one of skill in the art in possession of the present disclosure will appreciate how the secure boot configuration modification source identification message discussed above may be generated according to an action (e.g., “ALERT USER”) that is intended to alarm the user (e.g., when the computing device 200 is locked in a secure chassis to prevent access to the computing device 200 that would be required to perform the secure boot configuration modification using the input device 234) such as, for example, “The BIOS update was initiated via the USB storage device that required physical access to this secure computing device”, or “The BIOS update was initiated via a keyboard F2 instruction that required physical access to this secure computing device”. As such, one of skill in the art in possession of the present disclosure will appreciate how performance of the informational actions or alert actions described herein in response to modifications to secure boot configurations will depend on the particular security situation of the computing device in which the secure boot configuration was modified.

Similarly, a secure boot configuration modification source identification message generated at block 710 may be based on the secure boot configuration modification source identifier “2” discussed above and may identify the modification to the secure boot configuration 212, the secure boot configuration modification source of that modification, and or any other secure boot configuration modification information that would be apparent to one of skill in the art in possession of the present disclosure (e.g., “The secure boot configuration has been modified via a BMC GUI.”). In some embodiments, the secure boot configuration modification source identification message may be generated according to the action (e.g., “INFORM USER”) associated with the secure boot configuration modification source identifier “2” (e.g., the secure boot configuration modification source identifier message above may include an informational message (“The secure boot configuration was modified via the BMC GUI in an authenticated process”) that is intended to inform the user of the modification to the secure boot configuration without alarming the user.

Similarly, a secure boot configuration modification source identification message generated at block 710 may be based on the secure boot configuration modification source identifier “3” discussed above and may identify the modification to the secure boot configuration 212, the secure boot configuration modification source of that modification, and or any other secure boot configuration modification information that would be apparent to one of skill in the art in possession of the present disclosure (e.g., “The secure boot configuration has been modified via a personality module.”) In some embodiments, the secure boot configuration modification source identification message may be generated according to the action (e.g., “INFORM USER”) associated with the secure boot configuration modification source identifier “3” (e.g., the secure boot configuration modification source identifier message above may include an informational message (“The secure boot configuration was modified via a personality module in an authenticated process”) that is intended to inform the user of the modification to the secure boot configuration without alarming the user.

Similarly, a secure boot configuration modification source identification message generated at block 710 may be based on the secure boot configuration modification source identifier “5” discussed above and may identify the modification to the secure boot configuration 212, the secure boot configuration modification source of that modification, and or any other secure boot configuration modification information that would be apparent to one of skill in the art in possession of the present disclosure (e.g., “The secure boot configuration has been modified via the importation of secure boot certificates using an OOB RACADM or REDFISH tool.”) In some embodiments, the secure boot configuration modification source identification message may be generated according to the action (e.g., “INFORM USER”) associated with the secure boot configuration modification source identifier “5” (e.g., the secure boot configuration modification source identifier message above may include an informational message (“The secure boot certificates where imported using the OOB RACADM or REDFISH tool in an authenticated process”) that is intended to inform the user of the modification to the secure boot configuration without alarming the user.

As discussed above, a secure boot configuration modification source identification message generated at block 710 may be based on the default secure boot configuration modification source identifier “0” discussed above and may identify the modification to the secure boot configuration 212, the secure boot configuration modification source of that modification, and or any other secure boot configuration modification information that would be apparent to one of skill in the art in possession of the present disclosure (e.g., “The secure boot configuration has been modified via non-OEM runtime modifications to the secure boot configuration.”) In some embodiments, the secure boot configuration modification source identification message may be generated according to the action (e.g., “ALERT USER”) associated with the default secure boot configuration modification source identifier “0” (e.g., the secure boot configuration modification source identifier message above may include an informational message (“While the secure boot configuration modification during runtime could be part of an operating system update, it could be part of a malicious attack and thus its authorization should be confirmed”) that is intended to alarm the user.

As will be appreciated by one of skill in the art in possession of the present disclosure, the default secure boot configuration modification source identifier “0” may be set in the UEFI variable 224 and may remain following the initialization of the computing device 200 in the event no modifications are made to the secure boot configuration 212 during the initialization of the computing device 200. As such, in the event the first initialization hash value does not match the second initialization hash value at decision block 704 in such a scenario, the change in the secure boot configuration 212 must have been made by a non-OEM secure boot configuration modification performed during runtime, and as described above may result in the alerting the user of that modification within an intent to alarm the user in the event that modification was not authorized.

However, while several specific examples have been provided, one of skill in the art in possession of the present disclosure will appreciate how a variety of secure boot configuration modification source identification messages may be generated in response to the modification of the secure boot configuration by corresponding sources, and while the simplified examples above provide relatively limited information about the source of the modifications to the secure boot configuration, the systems and methods of the present disclosure may be enhanced to allow for the generation of secure boot configuration modification source identification messages with more detailed information about the source of the modification to the secure boot configuration, as well as details about that modification (e.g., date, time, etc.), while remaining within the scope of the present disclosure as well. As will be appreciated by one of skill in the art in possession of the present disclosure, following the generation of the secure boot configuration modification source identification message at block 710, in some embodiments the BIOS engine 206 in the BIOS 204 may reset the secure boot configuration modification source identifier storage provided by the non-volatile memory subsystem 226 (e.g., providing the default secure boot configuration modification source identifier “0” discussed above in the non-volatile memory subsystem 226).

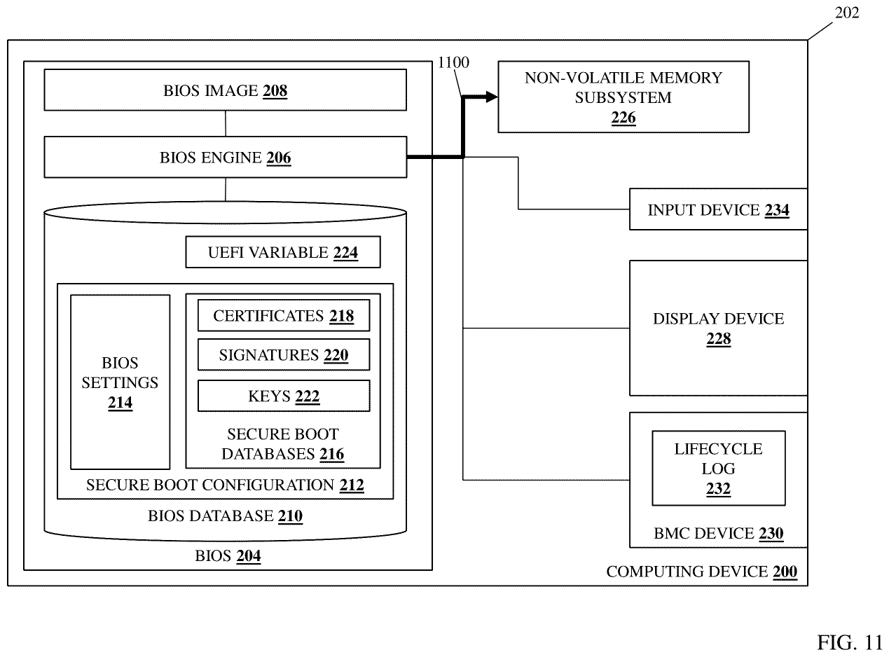

The method 700 then proceeds to block 712 where the BIOS subsystem replaces the second initialization hash value with the first initialization hash value. With reference to FIG. 11, in an embodiment of block 712, the BIOS engine 206 may perform initialization hash value update operations 1100 that include storing the “current”/first initialization hash value generated at block 702 in the non-volatile memory subsystem 224 in place of the “previous”/second initialization hash value discussed above (i.e., deleting the “previous”/second initialization hash value from the non-volatile memory subsystem 224, and storing the “current”/first initialization hash value generated at block 702 in its place in the non-volatile memory subsystem 224) so that it may be utilized similarly as the “second” initialization hash value discussed above in a subsequent iteration of the method 700 and during a subsequent initialization of the computing device 200. The method 700 then proceeds to block 706 where the BIOS subsystem completes the first initialization of the computing device substantially as described above.

While the secure boot configuration modification source identification of the present disclosure is discussed above as providing a secure boot configuration modification source identifier in the UEFI variable 224 during initialization of the computing device 200 and preventing the UEFI variable 224 from being modified during runtime of the computing device 200, one of skill in the art in possession of the present disclosure will appreciate how the secure boot configuration modification source identification system of the present disclosure may be modified to allow the UEFI variable 224 to be modified during runtime of the computing device 200. For example, if unauthorized UEFI variable modification can be sufficiently prevented (e.g., if the Advanced Configuration and Power Interface (ACPI) can be protected from malicious control such that unauthorized use of the ACPI to modify the UEFI variable 224 is prevented, the operating system provided on the computing device 200 during runtime may be allowed to set the UEFI variable 224 during that runtime similarly as described above by the BIOS engine 206).

Thus, systems and methods have been described that may identify the source of a modification to a secure boot configuration in a BIOS of a computing device, which was performed during a previous initialization of that computing device, during a current initialization of that computing device. For example, the BIOS secure boot configuration modification source reporting system of the present disclosure may include a computing device housing a BIOS that is coupled to a non-volatile memory subsystem and that includes a BIOS subsystem coupled to a BIOS database storing a secure boot configuration, and to a secure boot configuration modification source identifier storage. During a current initialization of the computing device, the BIOS subsystem uses the secure boot configuration to generate a current initialization hash value, determines that the current initialization hash value does not match a previous initialization hash value that is stored in the non-volatile memory subsystem and that was generated using the secure boot configuration during a previous initialization of the computing device and, in response, retrieves secure boot configuration modification source identifier(s) from the secure boot configuration modification source identifier storage and uses them to generate secure boot configuration modification source identification message(s). As such, modifications to secure boot configuration may be identified to users while reducing customer support calls and related issues with conventional secure boot configuration modifications systems discussed above.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

What is claimed is:

1. A Basic Input/Output System (BIOS) secure boot configuration modification source reporting system, comprising:
a computing device;
a non-volatile memory subsystem that is housed in the computing device; and
a Basic Input/Output System (BIOS) that is housed in the computing device, that is coupled to the non-volatile memory subsystem, and that includes:
a BIOS database storing a secure boot configuration;
a secure boot configuration modification source identifier storage; and
a BIOS subsystem that is coupled to the BIOS database and the secure boot configuration modification source identifier storage, wherein the BIOS subsystem is configured, during a first initialization of the computing device, to:
generate, using the secure boot configuration, a first initialization hash value;
determine that the first initialization hash value does not match a second initialization hash value that is stored in the non-volatile memory subsystem and that was generated using the secure boot configuration during a second initialization of the computing device that was performed prior to the first initialization of the computing device;
retrieve, from the secure boot configuration modification source identifier storage in response to determining the first initialization hash value does not match the second initialization hash value, at least one secure boot configuration modification source identifier; and
generate, using the at least one secure boot configuration modification source identifier, at least one secure boot configuration modification source identification message.

2. The system of claim 1, wherein the BIOS subsystem is configured, during the second initialization of the computing device, to:
receive, from a first secure boot configuration modification source, at least one first instruction to modify the secure boot configuration;
modify, based on the at least one first instruction to modify the secure boot configuration, the secure boot configuration; and
provide, in the secure boot configuration modification source identifier storage, a first secure boot configuration modification source identifier for the first secure boot configuration modification source.

3. The system of claim 2, wherein the first secure boot configuration modification source is associated with one of:
an input device connected to the computing device;
a Baseboard Management Controller (BMC) device included in the computing device; or
a BIOS image included in the BIOS.

4. The system of claim 2, wherein the BIOS subsystem is configured, during the second initialization of the computing device, to:
receive, from a second secure boot configuration modification source, at least one second instruction to modify the secure boot configuration;
modify, based on the at least one second instruction to modify the secure boot configuration, the secure boot configuration; and
provide, in the secure boot configuration modification source identifier storage, a second secure boot configuration modification source identifier for the second secure boot configuration modification source.

5. The system of claim 4, wherein the BIOS subsystem is configured, during the first initialization of the computing device, to:
generate, using the first secure boot configuration modification source identifier, a first secure boot configuration modification source identification message; and
generate, using the second secure boot configuration modification source identifier, a second secure boot configuration modification source identification message that is different than the first secure boot configuration source identification message.

6. The system of claim 1, wherein the at least one secure boot configuration modification source identifier is a default secure boot configuration modification source identifier.

7. The system of claim 1, wherein modifications to the secure boot configuration modification source identifier storage are prevented during runtime of the computing device.

8. An Information Handling System (IHS), comprising:
a processing system; and
a memory system that is coupled to the processing system and that includes instructions that, when executed by the processing system, cause the processing system to provide a Basic Input/Output System (BIOS) engine that is configured, during a first initialization of the IHS, to:
generate, using a secure boot configuration, a first initialization hash value;
determine that the first initialization hash value does not match a second initialization hash value that is stored in a non-volatile memory subsystem coupled to the processing system and that was generated using the secure boot configuration during a second initialization of the IHS that was performed prior to the first initialization of the IHS;
retrieve, from a secure boot configuration modification source identifier storage coupled to the processing system in response to determining the first initialization hash value does not match the second initialization hash value, at least one secure boot configuration modification source identifier; and
generate, using the at least one secure boot configuration modification source identifier, at least one secure boot configuration modification source identification message.

9. The IHS of claim 8, wherein the BIOS engine is configured, during the second initialization of the IHS, to:
receive, from a first secure boot configuration modification source, at least one first instruction to modify the secure boot configuration;
modify, based on the at least one first instruction to modify the secure boot configuration, the secure boot configuration; and
provide, in the secure boot configuration modification source identifier storage, a first secure boot configuration modification source identifier for the first secure boot configuration modification source.

10. The IHS of claim 9, wherein the first secure boot configuration modification source is associated with one of:
an input device connected to the processing system;
a Baseboard Management Controller (BMC) device included in the IHS; or
a BIOS image included in the memory system.

11. The IHS of claim 9, wherein the BIOS engine is configured, during the second initialization of the IHS, to:
receive, from a second secure boot configuration modification source, at least one second instruction to modify the secure boot configuration;
modify, based on the at least one second instruction to modify the secure boot configuration, the secure boot configuration; and
provide, in the secure boot configuration modification source identifier storage, a second secure boot configuration modification source identifier for the second secure boot configuration modification source.

12. The IHS of claim 11, wherein the BIOS engine is configured, during the first initialization of the IHS, to:
generate, using the first secure boot configuration modification source identifier, a first secure boot configuration modification source identification message; and
generate, using the second secure boot configuration modification source identifier, a second secure boot configuration modification source identification message that is different than the first secure boot configuration source identification message.

13. The IHS of claim 8, wherein the at least one secure boot configuration modification source identifier is a default secure boot configuration modification source identifier.

14. A method for reporting a source of modifications to a secure boot configuration in a Basic Input Output System (BIOS), comprising:
generating, by a BIOS subsystem during a first initialization of a computing device using a secure boot configuration, a first initialization hash value;
determining, by the BIOS subsystem during the first initialization of the computing device, that the first initialization hash value does not match a second initialization hash value that is stored in a non-volatile memory subsystem and that was generated using the secure boot configuration during a second initialization of the computing device that was performed prior to the first initialization of the computing device;
retrieving, by the BIOS subsystem from a secure boot configuration modification source identifier storage during the first initialization of the computing device and in response to determining the first initialization hash value does not match the second initialization hash value, at least one secure boot configuration modification source identifier; and
generating, by the BIOS subsystem during the first initialization of the computing device using the at least one secure boot configuration modification source identifier, at least one secure boot configuration modification source identification message.

15. The method of claim 14, further comprising:
receiving, by the BIOS subsystem during the second initialization of the computing device from a first secure boot configuration modification source, at least one first instruction to modify the secure boot configuration;
modifying, by the BIOS subsystem during the second initialization of the computing device based on the at least one first instruction to modify the secure boot configuration, the secure boot configuration; and
providing, by the BIOS subsystem during the second initialization of the computing device in the secure boot configuration modification source identifier storage, a first secure boot configuration modification source identifier for the first secure boot configuration modification source.

16. The method of claim 15, wherein the first secure boot configuration modification source is associated with one of:
an input device connected to the computing device;
a Baseboard Management Controller (BMC) device included in the computing device; or
a BIOS image included in a BIOS that includes the BIOS subsystem.

17. The method of claim 15, further comprising:
receiving, by the BIOS subsystem during the second initialization of the computing device from a second secure boot configuration modification source, at least one second instruction to modify the secure boot configuration;
modifying, by the BIOS subsystem during the second initialization of the computing device based on the at least one second instruction to modify the secure boot configuration, the secure boot configuration; and
providing, by the BIOS subsystem during the second initialization of the computing device in the secure boot configuration modification source identifier storage, a second secure boot configuration modification source identifier for the second secure boot configuration modification source.

18. The method of claim 14, further comprising:
generating, by the BIOS subsystem during the first initialization of the computing device using the first secure boot configuration modification source identifier, a first secure boot configuration modification source identification message; and
generating, by the BIOS subsystem during the first initialization of the computing device using the second secure boot configuration modification source identifier, a second secure boot configuration modification source identification message that is different than the first secure boot configuration source identification message.

19. The method of claim 14, wherein the at least one secure boot configuration modification source identifier is a default secure boot configuration modification source identifier.

20. The method of claim 14, wherein modifications to the secure boot configuration modification source identifier storage are prevented during runtime of the computing device.
